(19) United States
(12) Patent Application Publication
(10) Pub. No.: US 2019/0102783 A1
(43) Pub. Date: Apr. 4, 2019

(54) TARGETED ELECTRONIC MESSAGING AT A BRICK AND MORTAR STORE

(71) Applicant: Intel Corporation, Santa Clara, CA (US)

(72) Inventors: Addicam Sanjay, Gilbert, AZ (US); Jose Avalos, Chandler, AZ (US); Shoa-Wen Yang, San Jose, CA (US)

(21) Appl. No.: 15/721,027

(22) Filed: Sep. 29, 2017

(51) Int. Cl. G06Q 30/02; G06K 7/10; G06K 19/07

(52) U.S. Cl. CPC G06Q 30/0201; G06K 19/0723; G06K 7/10366

(57) ABSTRACT

Systems and methods for targeted electronic messaging within a brick and mortar store are disclosed. A shopper tracking system tracks the physical location and collects shopping behavior data of a shopper located within a brick and mortar store. The shopping behavior data is supplied to a real time bidding system. When a shopper moves within a predetermined distance from an electronic sign, the shopper tracking system signals the real time bidding system to conduct a contemporaneous auction and supply a message provided by a winning bidder, which is displayed on the electronic sign.

### TECHNICAL FIELD

Embodiments described herein generally relate to the fields of electronic messaging, and in particular, to systems and methods for electronically tracking shoppers and their behaviors within a brick and mortar store, and supplying targeted electronic messaging in response to their behaviors.

### BACKGROUND

Online shopping is increasingly popular, often to the detriment of existing brick and mortar stores. An increase in smartphone adoption and the coverage of mobile networks have created ubiquitous shoppers. Roughly 86% of 18-24 year olds own smartphones, closely followed by 85% of 25-34 year olds. Ebay and Amazon have increasingly become popular destinations with shoppers. Even a large retailer, Walmart, has an online store and has added ShippingPass, for $50/year, to compete with Amazon and its Prime membership. Many shoppers nowadays go to a physical store just to look at a product they intend to buy online, effectively turning physical stores into showrooms.

### BRIEF DESCRIPTION OF THE DRAWINGS

FIG. 1 is a block diagram of the components of a system for targeted electronic messaging at a brick and mortar store.

FIG. 2 is a data flow diagram of a targeted electronic messaging process for the system depicted in FIG. 1.

FIG. 3A is a front view of an example electronic sign useful with the system of FIG. 1, depicting physical slots for messages.

FIG. 3B depicts time slots for messages in the electronic sign of FIG. 3A.

FIG. 4 depicts how the system of FIG. 1 can use RFID signal interference to track shopper behavior and location within a brick and mortar store.

FIG. 5 is a block diagram of an example computer that can be used to implement some or all of the components of the system of FIG. 1.

FIG. 6 illustrates an domain topology for respective internet-of-things (IoT) networks coupled through links to respective gateways, according to an example;

FIG. 7 illustrates a cloud computing network in communication with a mesh network of IoT devices operating as a fog device at the edge of the cloud computing network, according to an example;

FIG. 8 illustrates a block diagram of a network illustrating communications among a number of IoT devices, according to an example; and

FIG. 9 illustrates a block diagram for an example IoT processing system architecture upon which any one or more of the techniques (e.g., operations, processes, methods, and methodologies) discussed herein may be performed, according to an example.

### DETAILED DESCRIPTION

The disclosed systems and methods provide a way to track shoppers within a brick and mortar store, by both collecting relevant data concerning their shopping behaviors, and physically tracking their locations within the brick and mortar store. Location data is useful for further refining the collected shopping behavior data. A shopper that spends a significant amount of time in a particular area may be more likely to be looking at items proximate to their location, in contrast to a shopper who passes by, who is likely on the way to a different section in the store. Specifics as to what a shopper is viewing can be further ascertained and refined by combining location tracking with other data gathering means. For example, changes in signals from RFID tags on products proximate a shopper may indicate that the shopper has picked up and is examining the tagged product. By referencing the product associated with a particular RFID tag and being aware of the shopper's physical location to within a meter accuracy, the disclosed systems and methods can potentially determine with a reasonably high reliability the sorts of products that the shopper is interested in.

A further advantage the disclosed systems and methods can provide is targeted messaging. Various interested parties, e.g. manufacturers of products within the store and/or the store operator, may provide such messages, which can be delivered to one or more electronic signs located throughout the brick and mortar store. In some embodiments, the shopper's identification and shopping behavior data may be supplied continuously to a real time bidding system, which may conduct contemporaneous auctions to interested bidders for the opportunity to place a message upon an electronic sign proximate to the shopper when the shopper comes within a predetermined distance from the sign. Messages can be of any nature, e.g. commercial, such as customized pricing, suggested additional items of interest, promotions, product information and highlights; or can be more in the form of information or public service announcements, e.g. warning of possibly harmful effects of product misuse, product news and future developments, etc. In this way, a shopper's experience at the brick and mortar store can be personalized in a similar fashion to that experienced by the shopper in an online setting.

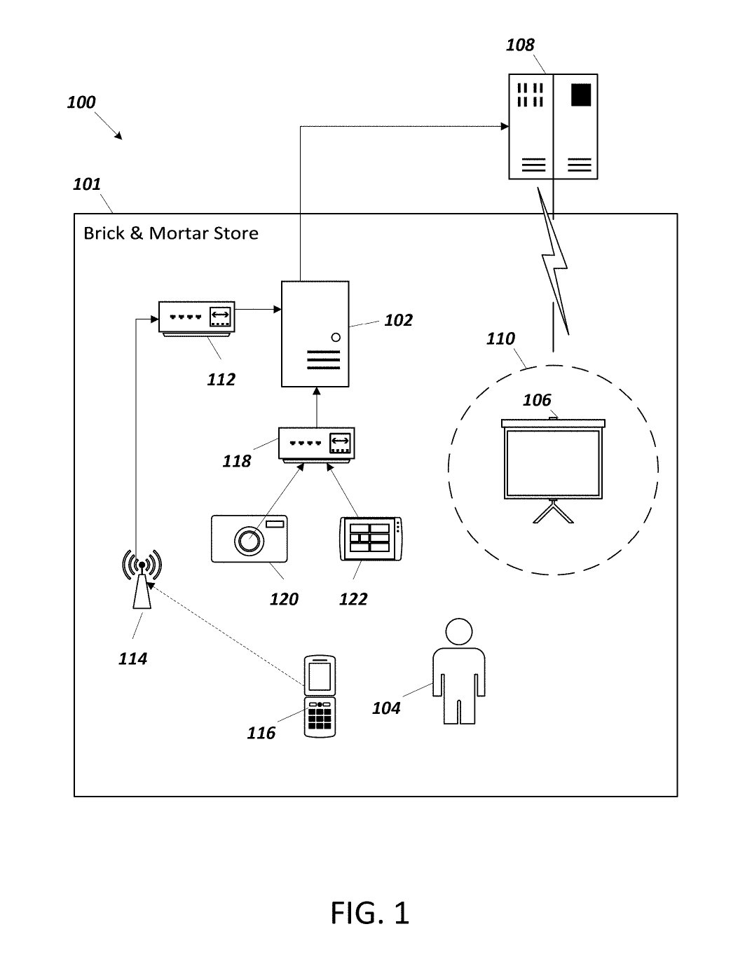

As seen in FIG. 1, an embodiment of a system 100 provides targeted electronic messaging at a brick and mortar store 101, and may include a shopper tracking system 102, which may be located within the brick and mortar store 101 (also referred to herein simply as “store 101”). Shopper tracking system 102 may collect shopping behavior data of a shopper 104 as well as track the physical location of shopper 104 while within the brick and mortar store 101. An electronic sign 106 may be disposed within the brick and mortar store 101 to display electronic messages. Shopper tracking system 102 may continuously provide shopping behavior data to a real time bidding (RTB) system 108 remote from the brick and mortar store 101, and provide a notification to the real time bidding system 108 when the shopper 104 is within a predetermined distance 110 to electronic sign 106. This notification may cause the RTB system 108 to display an electronic message in or during a message slot of electronic sign 106 for the shopper, the electronic message being of a contemporaneous winning bidder of the real time bidding system 108 for the message slot. The winning bidder may e.g., be a bidder with the highest bid for the message slot. In embodiments, the message slot may be a physical slot or a time slot.

Although a single electronic sign 106 is disclosed, it should be appreciated that system 100 may be configured with any arbitrary number of electronic signs 106, which may be distributed throughout the brick and mortar store 101. In such embodiments, each electronic sign 106 is potentially capable of receiving its own set of electronic messages, independent from the other electronic signs 106. Still other embodiments may have all electronic signs 106 configured to receive and display identical messages, depending upon the particulars of a given implementation of system 100.

Brick and mortar store 101 can be any building suitably sized to accommodate the on-site components of system 100, such as the electronic signs, sensors to track the shoppers, and so forth. Where system 100 employs sensors and techniques that allow tracking the location of a shopper 104 with sub-meter meter accuracy, system 100 can be employed in stores 101 that have a relatively small physical footprint, common in many so-called “mom and pop” stores. Likewise, system 100 can be scaled to accommodate stores that have a footprint stretching into hundreds of thousands of square meters, as is typical of many “big box” stores, such as those operated by Target or Walmart. Depending on the type of sensors employed and desired tracking accuracy, stores 101 with larger footprints may require the number of sensors employed with system 100 to be correspondingly increased to an appropriate ratio to the area of store 101, to provide acceptable coverage.

Still further, a single system 100 may be scaled to accommodate deployment across multiple stores 101, where each store 101 may be geographically separate for other stores 101. Scaling system 100 may, in some embodiments, entail deployment of multiple instances of shopper tracking system 102 associated with a single system 100. An example of such a deployment could be considered for a nationwide chain store, where a single system 100 may be scaled and deployed across all stores 101 in the chain, potentially allowing shopping behavior data to be collected and aggregated across all stores 101 in the chain, and/or potentially allowing shopping behavior data from a single shopper 104 to be tracked and gathered across visits to different stores 101 in the chain, such as where a shopper 104 may visit several different Walmarts or Targets.

The phrase “brick and mortar” should be understood to be figurative for a general physical area, and not as limiting system 100 to embodiments that are implemented within a store constructed from actual bricks and mortar. Store 101 may be constructed using any suitable building material(s) and techniques as are now known or later developed in the building trades, such as steel, concrete, or wood-frame (aka stick-built), to name a few of the most common methods of construction, or temporary structures, such as tents, canopies, modular buildings, and the like. Moreover, store 101 need not be an actual, enclosed brick and mortar store. In some embodiments, system 100 may be deployed to cover an unenclosed geographic region, such as may be encountered at a farmer's market, county or state fair, or outside bazaar. In such deployments, the phrase “brick and mortar” may simply refer to a defined geographic region, without regard to a particular structure. In some embodiments such an area could cover multiple structures, such as a fair or expo where structures such as trailers and/or modular buildings may be deployed within a wider geographic area, and tracking of shopping behavior across multiple vendors and structures is desired.

Similarly, system 100 need not be deployed to cover the entire area enclosed by a store 101. Embodiments of system 100 may be deployed in only a portion or a few portions of store 101. For example, most stores have an area or areas designated for employees only, such as back areas where surplus stock is kept, store offices, and breakrooms, or other areas where customers are allowed but do not have saleable goods, such as restrooms. In such stores 101, system 100 might only be deployed in physical areas where customers are expected to engage in behavior relevant to tracking, such as a retail floor. Further, where store 101 is a multi-use facility such as a convention center or expo grounds, multiple instances of system 100 may be deployed at various separate geographic locations within store 101, such as different convention halls.

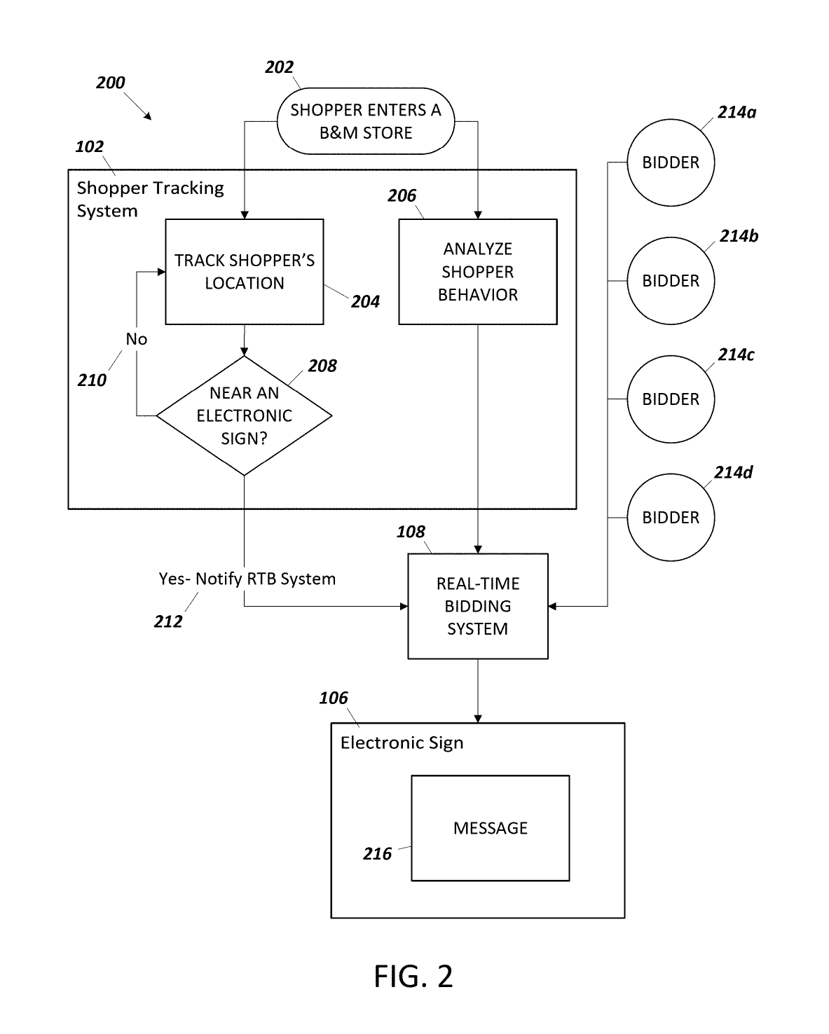

Shopper tracking system 102 may carry out the task of collecting shopping behavior data as shopper 104 moves throughout store 101, as well as shopper's 104 physical location. FIG. 2 demonstrates one possible process flow 200 for an embodiment of system 100 as shopper tracking system 102 interacts with real time bidding system 108 to provide messages for display on electronic sign 106. Process flow 200 may start when a shopper 104 enters into brick and mortar store 101 in block 202. Shopper tracking system 102 may commence tracking of shopper's 104 location in block 204, and may analyze shopper's 104 shopping behavior in block 206 to obtain shopping behavior data. As shopper 104 moves through brick and mortar store 101, shopper tracking system 102 may continuously supply shopping behavior data of shopper 104 to real time bidding system 108. Shopper tracking system 102 may also continuously determine the distance between shopper 104 and electronic sign 106. If shopper 104 is not within the predetermined distance 110 from electronic sign 106, shopper tracking system 102 may iterate back 210 and return to monitoring the location of shopper 104 in block 204. However, should shopper 104 be within the predetermined distance 110 from electronic sign 106, shopper tracking system 102 may notify 212 the real time bidding system 108 of the location of shopper 104, and then may send a message 216, hopefully relevant to shopper 104, to electronic sign 106 for display within the proximity of shopper 104. Shopper 104 can then chose to respond to message 216.

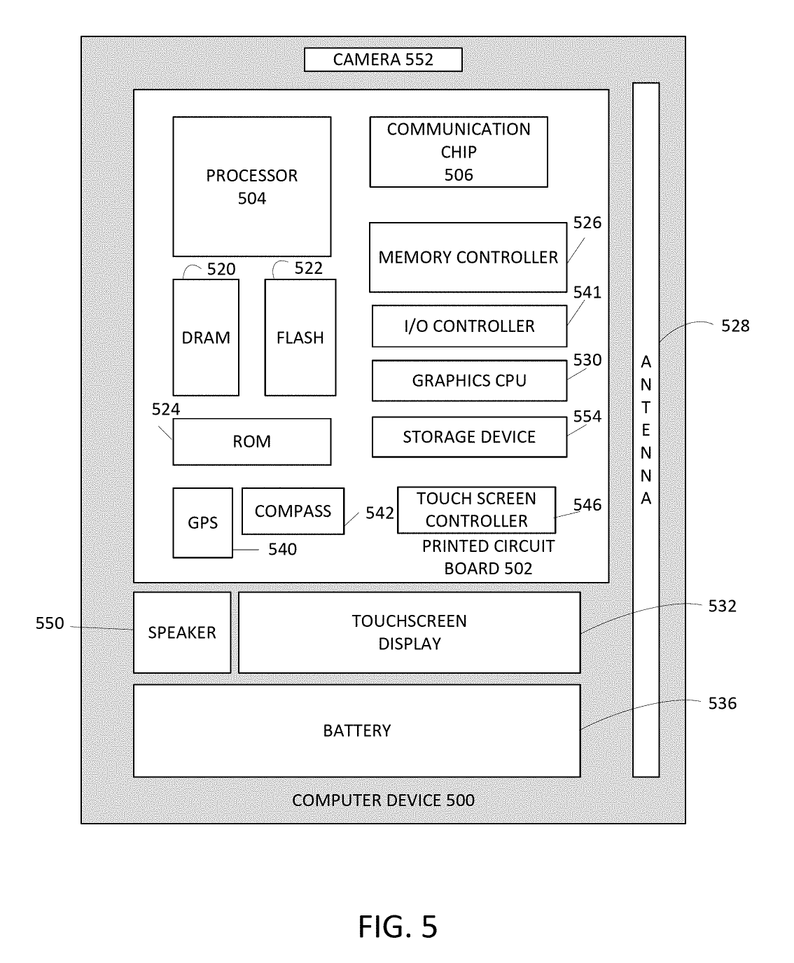

Depending on the embodiment, shopper tracking system 102 may be implemented using dedicated, custom programmed hardware, a general purpose computer device or computer devices running specific software that implements one or more of the components or functionality of shopper tracking system 102, or a combination of both. Examples of such computer devices are detailed herein with reference to FIG. 5. Moreover, a single system 100 may, in some embodiments, include multiple instances of a shopper tracking system 102, such as where a system 100 is deployed across multiple stores 101, and single shopper tracking system 102 is deployed for each store 101. Still other embodiments may have a single shopper tracking system 102 be deployed across multiple stores 101, and yet other embodiments may have multiple shopper tracking systems 102 be deployed in a single store 101, for example where a store 101 may have multiple departments, and it may be desirable to deploy separate shopper tracking systems 102 for various departments.

In some embodiments, shopper tracking system 102 may collect shopping behavior data and may track shopper's 104 physical location via a number of sensors. For location tracking, some embodiments may rely upon a unique piece of equipment that shopper 104 carries on his or her person, such as a phone 116. In many embodiments, phone 116 may be a smartphone, such as an iPhone or Android phone, effectively a mobile implementation of a computer device as described herein with reference to FIG. 5. Such phones 116 may typically be WiFi-enabled. Shopper tracking system 102 may then employ WiFi fingerprinting, with the unique WiFi characteristics of a given phone 116 identifiable and trackable by access point 114 when it is in WiFi communication with phone 116. The precise location of access point 114 may be determined during the implementation of shopper tracking system 102. Using signal strength drop off and depending on the configuration of access point 114, the location of phone 116, and by extension, shopper 104, can be determined and tracked over time with reference to the known location of access point 114. Employing multiple access points 114, each with known locations, may allow for more precise location fixing of shopper 104 by cross referencing data between all access points 114 in WiFi range of phone 116, and/or by using well-known triangulation techniques. The positioning of such access points 114 may also take accuracy into consideration. A greater number of access points 114 may allow for easier tracking of multiple shoppers 104, and so it may be desirable to deploy multiple access points 114 in a greater density around areas where high shopper traffic is expected.

The precision of determining the physical location of shopper 104 may be improved by integrating data from sensors inside of phone 116, such as the gyroscopes, magnetometers, and accelerometers found inside most smartphones, which allow the position and movements of phone 116, and by extension, shopper 104, to be determined. This additional data can be combined with WiFi fingerprinting to determine the position of shopper 104 with sub-meter accuracy. Integrating such sensor information may, in some embodiments, require the installation of an app on phone 116.

Some embodiments may encourage or require installation of an appropriate app on phone 116. Such an app may allow a shopper 104 to supply information relevant to their shopping experience voluntarily, such as listing hobbies, interests, personal information (e.g. marital status, ethnicity, age, income, gender, home area, etc.). System 100 may, in various embodiments, pass this information on to RTB system 108.

In other embodiments, shopper tracking system 102 may use a radio frequency identification (RFID) tag or similar technology to track shopper 104. Such implementations of system 100 may require shopper 104 to opt in to being tracked, to obtain the necessary RFID tag. Shoppers 104 may be encouraged to opt in via a variety of means, such as the possibility to receive, via system 100, offers that provide personalized deals over shoppers that do not opt in to being tracked by system 100. RFID tags may be scanned via access point 114 where properly equipped, or access point 114 may alternatively be implemented as an RFID scanner, rather than a WiFi access point. Furthermore, although RFID tags are described as possible embodiments, still other embodiments may employ other technology now known or later developed that allows for precision tracking of shopper 104 in a physical area.

In still other embodiments, tags used with shopper tracking system 102 may be located in other devices or items that are unique to and in physical possession of shopper 104. Examples of such items can include smart devices such as smart watches, chips, or tags that may be incorporated into items such as credit cards or ID badges, or other wearable items. Still other examples may rely upon near-field communication (NFC) technology. Such NFC technology may be present in a variety of personal items, including smartphones, smart watches, digital or electronic credit cards, etc. As with WiFi fingerprinting, RFID, tags, or NFC technology may be used for tracking shopper 104.

It can be seen in FIG. 1 that access point 114 may be in communication with shopper tracker 112, which in some embodiments may serve to aggregate and process the raw data from various sensor means for tracking shopper 104. In some embodiments, shopper tracker 112 may be a discrete component that may be implemented in hardware. Other embodiments may omit shopper tracker 112, or incorporate shopper tracker 112 into shopper tracking system 102, either using dedicated hardware, a software module, or a combination of both. It should also be understood that although FIG. 1 only depicts a single access point, this is for illustration purposes only, and a given embodiment of system 100 may include multiple access points 114 that can be geographically dispersed throughout brick and mortar store 101 as needed to ensure the desired physical area is covered. Each access point 114 may feed into either shopper tracker 112 or shopper tracking system 102. Moreover, some embodiments of shopper tracking system 102 may use multiple shopper trackers 112, or have some sensors feed into one or more shopper trackers 112 as well as into shopper tracking system 102 directly.

Some embodiments of shopper tracking system 102 may employ facial recognition and/or object recognition to track shopper 104, in addition to or in lieu of a physical device that is unique to and in the physical possession of shopper 104. In such embodiments, shopper 104 need not carry a phone 116 or RFID tag; rather, one or more cameras 120 may detect and positively identify shopper 104 based on facial recognition, and then track the position of shopper 104 within brick and mortar store 101. Still other embodiments of shopper tracking system 102 may use a combination of the techniques listed herein, such as hybrid WiFi signature and sensors from phone 116, facial recognition via camera(s) 120, and/or RFID tags.

Where an embodiment of shopper tracking system 102 assigns a unique identifier to shopper 104, possibly gathered using one of the foregoing techniques for tracking a unique shopper 104, this information may be passed on to RTB system 108.

In embodiments, shopper tracking system 102 may also track the behavior of shopper 104 to gather shopping behavior data, which may be continuously provided to RTB system 108. Shopping behavior data may be gathered using a variety of sensors, similar to tracking the physical location of shopper 104. In FIG. 1, in some embodiments camera 120 may be employed along with the facial and object recognition techniques referenced above to determine the behavior of shopper 104 and generate corresponding shopping behavior data, which may then be tagged specifically to shopper 104. Various embodiments may employ facial recognition techniques to analyze the reaction of shopper 104 to various products, e.g. determining emotional responses, and/or may detect other shopper 104 attributes such as ethnicity, gender, age, etc., which can be used to add demographic aspects to the collected shopping behavior data. This additional data may be fed to RTB system 108 in instances where RTB system 108 may factor such demographic information into auctions.

In various embodiments, camera 120 may be used to correspond a particular shopper 104 (who may be at least partially identified based on physical location and a known position of camera 120) with a particular good or goods proximate to shopper 104. Object detection can allow some embodiments of system 100 to ascertain which goods shopper 104 may be looking at and/or handling, thereby allowing system 100 to generate and report relevant shopping behavior data to RTB system 108.

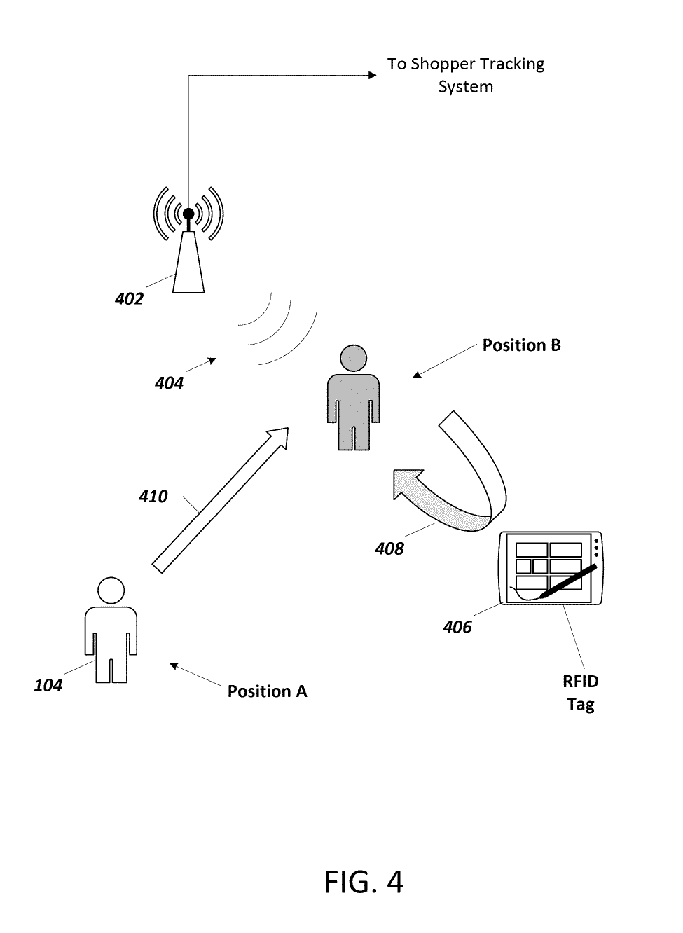

Other embodiments of shopper tracking system 102 may use other sensors and associated techniques to gather shopping behavior data on shopper 104, such as RFID signal interference detection 122. FIG. 4 illustrates how RFID signal interference may be used to determine shopper 104 behavior in some embodiments. A shopper 104 may be in initial position A, proximate to, but not in the path defined between an RFID reader 402 and an RFID tag-equipped item 406. In normal operation, RFID reader 402 may emit a signal 404 that may be received by the RFID tag in item 406. The RFID tag in item 406 may respond 408 with its unique information, which RFID reader 402 in turn may pick up. When shopper 104 moves into position B, in the path defined by RFID reader 402 and item 406, signal 404 as well as response 408 may be substantially blocked, preventing RFID reader 402 from receiving a proper response to signal 404. By detecting this loss of response 408 and/or a possible reflection of signal 404, and correlating with the type of item 406 that is RFID tagged, shopper tracking system 102 may ascertain at least the types of items 406 to which shopper 104 is proximate. Furthermore, where shopper 104 handles a particular item 406, intermittent and/or garbled responses 408 may be received, which may be analyzed in some embodiments to distinguish between shopper 104 actually handling item 406, or simply walking past item 406. Embodiments where RFID signal interference may be combined with facial and object recognition as well as physical location tracking may yield more accurate shopping behavior data, such as distinguishing between a shopper 104 who is actively examining an item 406, or is facing away and just happens to be proximate to item 406.

As with shopper tracker 112, in some embodiments, camera 120 and RFID signal interference detector 122 may feed into a shopping behavior data collector 118 for aggregation and/or preprocessing of sensor data. Depending on the embodiment, shopping behavior data collector 118 may be implemented as a discrete hardware component, may be implemented as one or more software modules on shopper tracking system 102, may be implemented as a combination of both hardware and software, or may be omitted entirely, where the functionality of shopping behavior data collector 118 may be handled by other modules or components of shopper tracking system 102.

Although FIG. 1 depicts a single camera 120 and RFID interference detector 122, it should be understood that this is for example purposes only. Embodiments of system 100 may be equipped with multiple cameras 120 and/or RFID interference detectors 122, depending upon the particular needs of a given implementation.

In various embodiments, the shopping behavior data for a given shopper 104 may be stored and retrieved within shopper tracking system 102 each time the shopper 104 enters within brick and mortar store 101. Such data may be tagged with information identifying the shopping behavior data with a particularly identified shopper 104. Other embodiments may store shopping behavior data for a given shopper 104 that may be collected from various stores 101 that may be unrelated to each other. Such embodiments may determine that shopper 104 is looking for a particular item or type of item, perhaps searching for a particular price or configuration, which may be valuable information to feed to RTB system 108. Embodiments of system 100 that store and retrieve shopping behavior data across multiple visits to the same store 101 or to different stores 101 owned/operated by different parties may provide better personalization of messages delivered to electronic sign 106 for shopper 104. In such embodiments, RTB system 108 may have a greater amount of data to draw from in selecting message providers and message content to participate in a given real-time auction.

Some embodiments may either not store historic shopping behavior data, or may instead rely upon RTB system 108 to store historic shopping behavior data. Where RTB system 108 is relied upon to store shopping behavior data, shopper tracking system 102 may simply send RTB system 108 an identifier unique to shopper 104 along with the shopping behavior data, which RTB system 108 may then use to reference stored historic shopping behavior data. Depending upon the RTB system 108 employed, RTB system 108 may automatically track and aggregate shopping behavior data from multiple visits to various unrelated stores 101 that are derived from a single identified shopper 104.

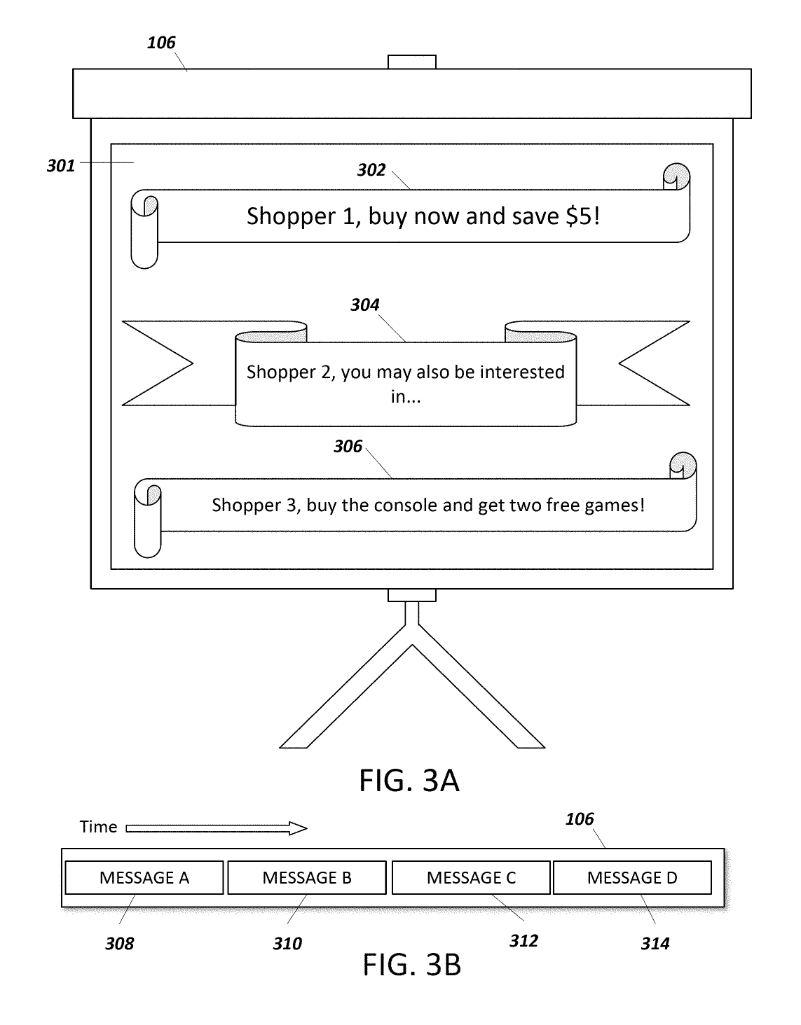

Referring to FIG. 3A, electronic sign 106 may include a display area 301 where various messages 302, 304, 306 received from real time bidding system 108 may be displayed. Display area 301 may be implemented using any display technology now known or later developed that is capable of displaying arbitrary content. Such technologies may include CRT, LCD, LED, OLED, DLP, projection, or any other similar display type. Electronic sign 106 may be implemented as a single unit, similar to an “all in one” type computer, or with multiple units. In single-unit implementations, equipment for receiving the messages 302, 304, 306 and driving display area 301, as well as display area 301, may be housed in a single physical package. Conversely, multiple unit implementations may place display area 301 into a single package, such as a computer monitor, with equipment for receiving messages and driving display area 301 placed into a separate package, such as a computer or CPU box. Still other multiple unit embodiments may implement display area 301 as a projector screen and corresponding projector, with equipment for receiving messages and driving display area 301 either integrated into the projector unit, or housed in a separate box.

FIGS. 3A and 3B also depict one possible arrangement of slots for messages from real time bidding system 108. In embodiments, electronic sign 106 may support either physical message slots, time-based message slots, or a combination of both. FIG. 3A may show a possible embodiment of physical message slots. Display area 301 can be divided into physical areas, with each area containing a message and thus forming a physical message slot. As depicted in FIG. 3A, messages 302, 304, and 306 may each occupy one physical message slot, each differ in content, and each occupy different physical areas of display area 301. Shopper tracking system 102 may instruct real time bidding system 108 as to an identity of a specific shopper 104 for a specific message. This allows real time bidding system 108 and/or electronic sign 106 to customize each message 302, 304, 306 to an intended shopper 104 for simultaneous display, thereby accommodating multiple shoppers 104 who may all be within the predetermined distance 110 from electronic sign 106.

Although FIG. 3A depicts the message slots oriented in a roughly horizontal fashion, other embodiments may provide slots that are oriented substantially vertically, a combination of both horizontal or vertical areas, a series of squares, rectangles or other polygons, or some combination of any of the foregoing. Each physical message slot need not be of identical size; some embodiments may allow physical message slots of varying sizes and shapes, including, in some embodiments, a message that occupies the entirety of display area 301, limiting electronic sign 106 to the display of a single message. The particular physical message slot configuration may depend on such factors as the number of shoppers 104 proximate to electronic sign, the content of the supplied messages, the amount paid (if any) by the winning bidder of a particular message slot, the length of time the message has been displayed in the message slot, among other factors. Moreover, the configuration of the various physical message slots may be dynamic in some embodiments, with the number, shape, and size of the various physical message slots changing over time, including a physical message slot being reconfigured to different dimensions over time while retaining its message.

FIG. 3B depicts time-based message slots. Such slots may occupy a single physical message slot on electronic sign 106, but change messages over time. Winning bidders in real time bidding system 108 may be awarded a particular amount of time designated to each physical message slot, which comprises a time-based message slot. Once the designated amount of time elapses, the time-based message slot may be released to accept a new message from a potentially different winning bidder. The length of time for each time-based message slot may be determined by any number of methods, e.g. a fixed predetermined time amount, or a flexible time amount. A flexible time amount can be based upon a variety of criteria, including an amount bid for a given message slot (higher amounts may mean a longer slot time), shopper interest, message content (messages with more information may need a longer time slot), etc., or some combination of these or other factors. Time slot lengths may be determined by the operator of system 100, the operator of RTB system 108 (if different from the operator of system 100), the manufacturer of electronic sign 106, or any other appropriate party, depending upon the particulars of a given embodiment.

Where electronic sign 106 is configured to present a single message, that is, the entirety of display area 301 is devoted to a single physical message slot, time-based message slots may be employed to allow electronic sign 106 to present messages to different shoppers 104. It should also be apparent that in some embodiments time-based message slots can be used in conjunction with one or more physical message slots. In such embodiments, multiple messages in different physical message slots may be displayed simultaneously, with time-based slots used for one or more of the different physical message slots.

The use of message slots, both physical and time-based, may allow system 100 to accommodate tracking of multiple shoppers 104. In some embodiments, when system 100 detects multiple shoppers 104 within predetermined distance 110 of an electronic sign 106, it may cause electronic sign 106 to reconfigure with multiple physical message slots corresponding to the number of shoppers 104 within predetermined distance 110. Other embodiments may employ time-based message slots, cycling through messages directed to each of the various shoppers 104, while other embodiments may combine both physical and time-based message slots, as described above. Still other embodiments may simply either pick one of the various shoppers 104 randomly or use some selection criteria, e.g. closest to electronic sign 106 or ranked as a more likely customer, to determine who to target a message.

Configuration of a given electronic sign 106 may be handled by shopper tracking system 102, which may, in some embodiments, act as an intermediary for delivering messages from RTB system 108 to electronic sign 106. In such embodiments, shopper tracking system 102 may determine the best way to manage electronic sign 106, such as configuration of various physical message slots, and when/where to employ time-based message slots. Other embodiments may push such configuration onto electronic sign 106, which may locally determine the best way to present multiple messages. In such embodiments, each message may include information such as a desired size (where physical message slots are employed) and/or desired display time (where time-based message slots are employed). Still other embodiments may allow RTB system 108 to determine the configuration of electronic sign 106 directly.

Various embodiments may combine tracking with data identifying each shopper 104 uniquely, for example, to enable multiple messages to be displayed simultaneously on electronic sign 106. This scenario is depicted in FIG. 3A, where each message 302, 304, and 306 is directed to a specific shopper. One possible method of achieving this personalization may be by passing such information onto RTB system 108, which, in some embodiments, may use the unique identification of a given shopper 104 to auction messaging that is tailored to the specific demographic and shopping profile of the given shopper 104.

Real time bidding (RTB) system 108 may supply messaging content from a number of competing message content providers. While the mechanics of how such RTB systems 108 function may vary depending on the particular provider, the basic principles tend to be consistent: such systems accept bids from a variety of different message content providers/owners (bidders), showing some monetary amount that each bidder is willing to use in auctions for placement of message content. At the same time, RTB systems 108 may accept requests from various providers of message display space (such as an implementer of an embodiment of system 100) to provide relevant message content. When RTB system 108 is notified by a display space provider of an available message slot, RTB system 108 may select interested bidders and conduct an automated auction where the interested bidders can bid amounts they are each willing to pay to have their respective messages displayed in the available message slot. Real time bidding system 108 may then award the message slot to the bidder or bidders with the highest bid amount(s). Thereafter, the message content from the winning bidder(s) may be transmitted by the winning bidder(s) or the real-time bidding system (if the message content had been provided to the real-time bidding system) to the display space provider for display in the available message slot.

As described above, in embodiments shopper tracking system 102 may supply RTB system 108 a variety of information in shopping behavior data. Such data may include an identifier unique to each shopper 104, allowing RTB system 108 to conduct separate auctions for message slots for each shopper 104 and/or to customize particular messages for a given shopper 104. Where system 100 is implemented with multiple electronic signs 106, such information may also include the particular electronic sign 106 to which a given shopper 104 is proximate, to ensure shopper 104 sees messages designated form them. As illustrated by FIG. 3A, in some embodiments where multiple messages are displayed on electronic sign 104, RTB system 108 may be supplied with information about the physical configuration of electronic sign 106 to determine quantity and/or appropriate pricing of messages. In other embodiments, RTB system 108 may simply be provided with the overall parameters of electronic sign 106 (e.g. the size of display area 301 and/or message time length), with RTB system 108 using such information to determine quantity and/or appropriate pricing.

RTB system 108 may be operated independently from shopper tracking system 102, or it may be operated by a single entity as part of an embodiment of system 100. Where RTB system 108 is operated independently, it may be in the form of an established RTB system that is in use with websites, which can be adapted to service system 100. Where RTB system 108 is also employed with websites, in some embodiments RTB system 108 may be able to correlate and integrate shopping behavior data obtained from the online activities of shopper 104 with the shopping behavior data obtained from store 101. Thus, RTB system 108 may utilize the online shopping behavior data to personalize messaging directed to shopper 104 further via electronic sign 106. Other embodiments may employ RTB system 108 to integrate shopping behavior data obtained from multiple instances of a store 101, such as where an operator of a single system 100 operates multiple stores 101, as in the case of chain stores. RTB system 108 may receive shopping behavior data from across all or some of the multiple stores 101, and in some embodiments may receive shopping behavior data for a single shopper 104's visits to multiple stores 101. In some embodiments, RTB system 108 may additionally integrate online shopping behavior data, which may include shopping behavior data obtained from a website also operated by the operator of store 101 or multiple stores 101. In still other embodiments, system 100 may use an existing RTB system 108 (such as the RTB systems in place from Google) to conduct auctions and obtain messages, with system 100 then handling management and placement of messages on electronic signs 106.

In still other embodiments, RTB system 108 may service multiple implementations of system 100, where each implementation of system 100 may be owned/operated by different, unrelated entities. For example, a first embodiment of system 100 may be operated by a first party who operates a first store 101, and a second embodiment of system 100 may be operated by a second party who operates a second store 101, with the first party and second party being unrelated. Each of the first embodiment and second embodiment of system 100 may interface with a single RTB system 108, which may supply content for a first set of electronic signs 106 associated with the first embodiment of system 100, and a second set of electronic signs 106 associated with the second embodiment of system 100. It should be appreciated that this is merely an example, and a given RTB system 108 may be configured to interact, potentially including both receiving disparate and unrelated shopping behaviors as well as supplying unrelated messages, with any number of different systems 100.

In some embodiments of system 100, the displayed messages may offer special deals, companion products, targeted/specific pricing, etc., to a given shopper 104. Where such messages are displayed, system 100 may be configured to interface with the point of sale (POS) systems of the operator of store 101, to supply necessary deal information. As system 100 tracks the physical location of shopper 104, it may detect when the shopper 104 is at a register or check out terminal, and may instruct the POS system to supply a targeted price to shopper 104. Some embodiments may do this automatically, e.g. an offer of directed pricing is made, shopper 104 takes the desired item to the store 101 register, and system 100, due to tracking of shopper 104, may convey the pricing automatically to store 101's POS system. Other embodiments may include an app on shopper's 104 smartphone, or possibly a kiosk or other interactive terminal proximate to and/or connected to electronic sign 106 that may allow shopper 104 to acknowledge a particular deal or pricing, and may supply a coupon or electronic code of some sort for use with the POS system. Still other embodiments may allow a shopper 104 to purchase or otherwise take advantage of a messaged offer at the point of presentation, possibly bypassing the need to check out through the store's 101 conventional POS systems.

FIG. 5 illustrates an example computer device 500 that may employ the apparatuses and/or methods described herein (e.g., the shopper tracking system 102, the electronic sign 106, the RTB system 108, and/or the phone 116), in accordance with various embodiments. As shown, computer device 500 may include a number of components, such as one or more processor(s) 504 (one shown) and at least one communication chip 506. In various embodiments, the one or more processor(s) 504 each may include one or more processor cores. In various embodiments, the one or more processor(s) 504 may include hardware accelerators to complement the one or more processor cores. In various embodiments, the at least one communication chip 506 may be physically and electrically coupled to the one or more processor(s) 504. In further implementations, the communication chip 506 may be part of the one or more processor(s) 504. In various embodiments, computer device 500 may include printed circuit board (PCB) 502. For these embodiments, the one or more processor(s) 504 and communication chip 506 may be disposed thereon. In alternate embodiments, the various components may be coupled without the employment of PCB 502.

Depending on its applications, computer device 500 may include other components that may be physically and electrically coupled to the PCB 502. These other components may include, but are not limited to, memory controller 526, volatile memory (e.g., dynamic random access memory (DRAM) 520), non-volatile memory such as read only memory (ROM) 524, flash memory 522, storage device 554 (e.g., a hard-disk drive (HDD)), an I/O controller 541, a digital signal processor (not shown), a crypto processor (not shown), a graphics processor 530, one or more antennae 528, a display (not shown but could include at least the display area 301 of electronic sign 106), a touch screen display 532, a touch screen controller 546, a battery 536, an audio codec (not shown), a video codec (not shown), a global positioning system (GPS) device 540, a compass 542, an accelerometer (not shown), a gyroscope (not shown), a speaker 550, a camera 552, and a mass storage device (such as hard disk drive, a solid state drive, compact disk (CD), digital versatile disk (DVD)) (not shown), and so forth.

In some embodiments, the one or more processor(s) 504, flash memory 522, and/or storage device 554 may include associated firmware (not shown) storing programming instructions configured to enable computer device 500, in response to execution of the programming instructions by one or more processor(s) 504, to practice all or selected aspects of the shopper tracking and/or targeted messaging methods described herein. In various embodiments, these aspects may additionally or alternatively be implemented using hardware separate from the one or more processor(s) 504, flash memory 522, or storage device 554.

The communication chips 506 may enable wired and/or wireless communications for the transfer of data to and from the computer device 500. The term “wireless” and its derivatives may be used to describe circuits, devices, systems, methods, techniques, communications channels, etc., that may communicate data through the use of modulated electromagnetic radiation through a non-solid medium. The term does not imply that the associated devices do not contain any wires, although in some embodiments they might not. The communication chip 506 may implement any of a number of wireless standards or protocols, including but not limited to IEEE 802.20, Long Term Evolution (LTE), LTE Advanced (LTE-A), General Packet Radio Service (GPRS), Evolution Data Optimized (Ev-DO), Evolved High Speed Packet Access (HSPA+), Evolved High Speed Downlink Packet Access (HSDPA+), Evolved High Speed Uplink Packet Access (HSUPA+), Global System for Mobile Communications (GSM), Enhanced Data rates for GSM Evolution (EDGE), Code Division Multiple Access (CDMA), Time Division Multiple Access (TDMA), Digital Enhanced Cordless Telecommunications (DECT), Worldwide Interoperability for Microwave Access (WMAX), Bluetooth, derivatives thereof, as well as any other wireless protocols that are designated as 3G, 4G, 5G, and beyond. The computer device 500 may include a plurality of communication chips 506. For instance, a first communication chip 506 may be dedicated to shorter range wireless communications such as Wi-Fi and Bluetooth, and a second communication chip 506 may be dedicated to longer range wireless communications such as GPS, EDGE, GPRS, CDMA, WiMAX, LTE, Ev-DO, and others.

In various implementations, the computer device 500 may be a laptop, a netbook, a notebook, an ultrabook, a smartphone, a computer tablet, a personal digital assistant (PDA), a desktop computer, or a server. In further implementations, the computer device 500 may be any other electronic device that processes data.

When shopping online, a user's behavior is typically tracked. Tracked behavior can include both visited sites as well as the content of visited sites. For example, both the fact that a user visits amazon.com as well as what, specifically, the user viewed while at amazon.com can be tracked and recorded. This tracked behavior information is useful for personalizing content, as it provides some measure of insight into the tracked user's interests and possible purchases. By supplying this information to a real time bidding system that feeds message space on various websites, the user can be presented with a variety of personalized messages and pricing for various goods and services while the user browses various websites. System 100 enables heretofore uncapturable shopping behavior within stores 101 to be captured. Combined with the placement of electronic signs 106, shoppers can be presented with personalized messaging relevant to their brick and mortar shopping experience, which can help brick and mortar retailers stay competitive with personalized online shopping experiences.

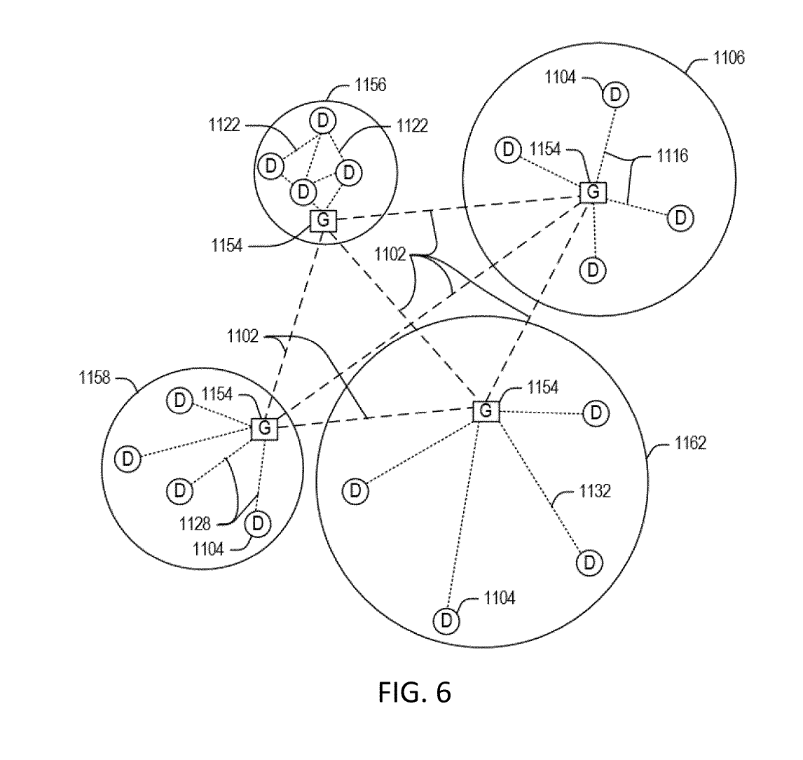

FIG. 6 illustrates an example domain topology for respective internet-of-things (IoT) networks coupled through links to respective gateways. The internet of things (IoT) is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

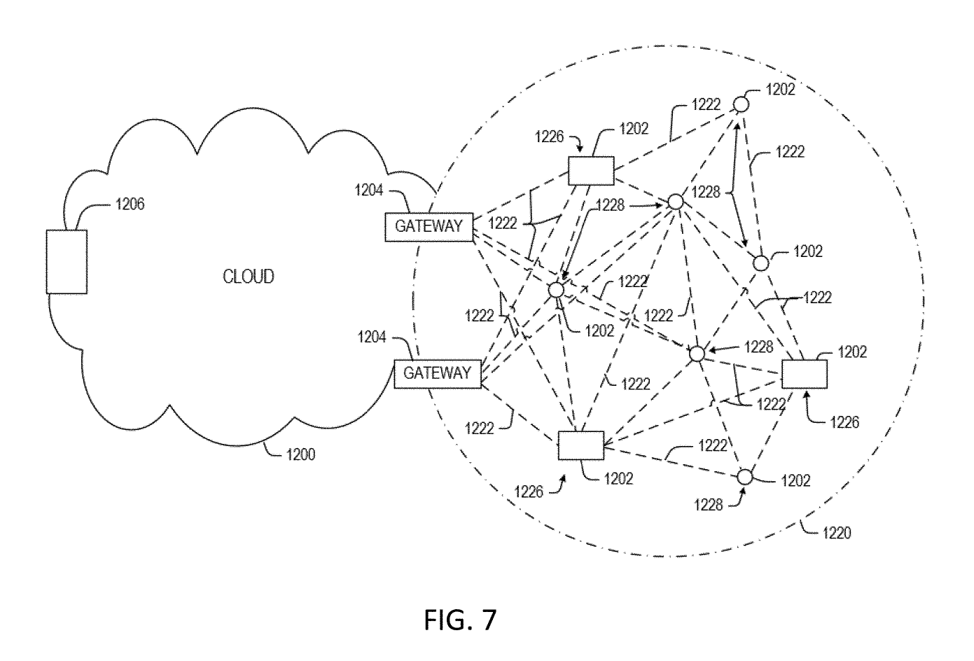

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 6 and 7, present a number of new challenges in a heterogeneous network of connectivity comprising a combination of wired and wireless technologies.

FIG. 6 specifically provides a simplified drawing of a domain topology that may be used for a number of internet-of-things (IoT) networks comprising IoT devices 1104, with the IoT networks 1156, 1158, 1160, 1162, coupled through backbone links 1102 to respective gateways 1154. For example, a number of IoT devices 1104 may communicate with a gateway 1154, and with each other through the gateway 1154. To simplify the drawing, not every IoT device 1104, or communications link (e.g., link 1116, 1122, 1128, or 1132) is labeled. The backbone links 1102 may include any number of wired or wireless technologies, including optical networks, and may be part of a local area network (LAN), a wide area network (WAN), or the Internet. Additionally, such communication links facilitate optical signal paths among both IoT devices 1104 and gateways 1154, including the use of MUXing/deMUXing components that facilitate interconnection of the various devices.

The network topology may include any number of types of IoT networks, such as a mesh network provided with the network 1156 using Bluetooth low energy (BLE) links 1122. Other types of IoT networks that may be present include a wireless local area network (WLAN) network 1158 used to communicate with IoT devices 1104 through IEEE 802.11 (W-Fi®) links 1128, a cellular network 1160 used to communicate with IoT devices 1104 through an LTE/LTE-A (4G) or 5G cellular network, and a low-power wide area (LPWA) network 1162, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 1104, such as over the backbone links 1102, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 1156, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 1158, for instance, may use systems that perform standards conversion to provide multi-standard connectivity, enabling IoT devices 1104 using different protocols to communicate. Further systems may provide seamless interconnectivity across a multi-standard infrastructure comprising visible Internet resources and hidden Internet resources.

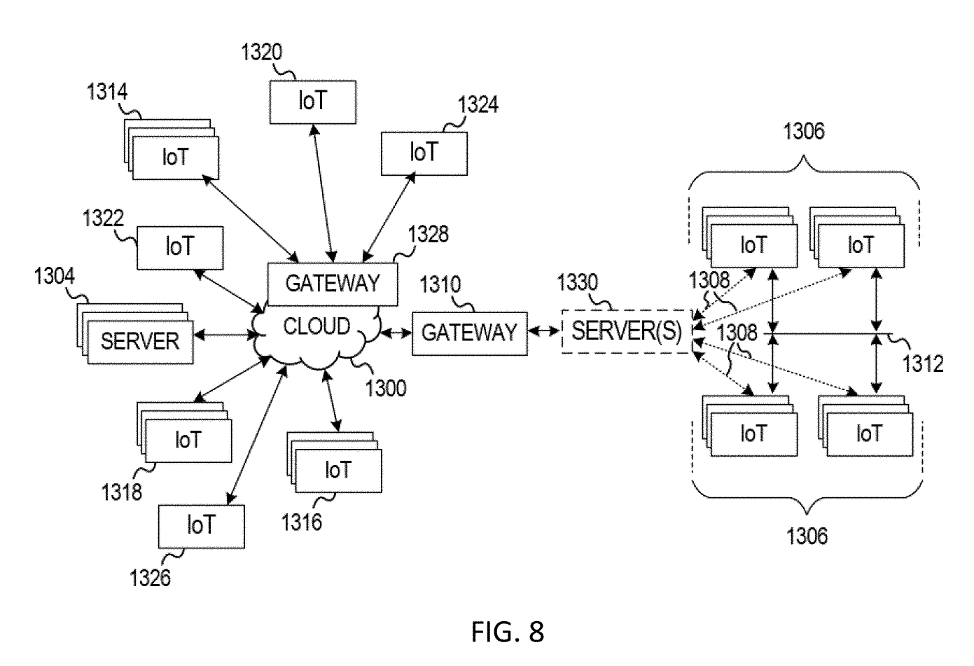

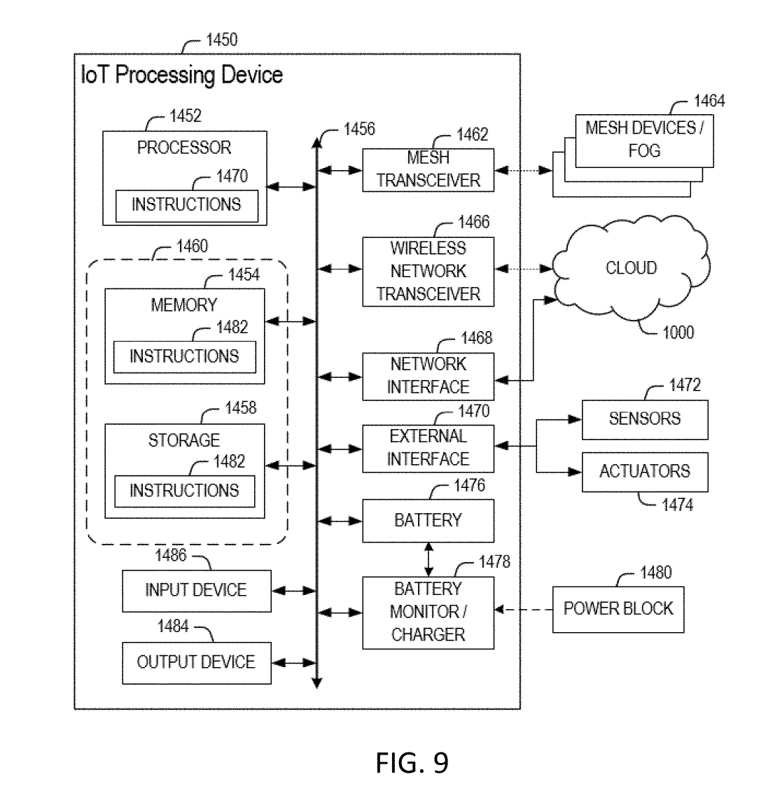

Communications in the cellular network 1160, for instance, may be enhanced by systems that offload data, extend communications to more remote devices, or both. The LPWA network 1162 may include systems that perform non-Internet protocol (IP) to IP interconnections, addressing, and routing. Further, each of the IoT devices 1104 may include the appropriate transceiver for wide area communications with that device. Further, each IoT device 1104 may include other transceivers for communications using additional protocols and frequencies. This is discussed further with respect to the communication environment and hardware of an IoT processing device depicted in FIGS. 8 and 9.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 7 below.

FIG. 7 illustrates a cloud computing network in communication with a mesh network of IoT devices (devices 1202) operating as a fog device at the edge of the cloud computing network. The mesh network of IoT devices may be termed a fog 1220, operating at the edge of the cloud 1200. To simplify the diagram, not every IoT device 1202 is labeled.

The fog 1220 may be considered to be a massively interconnected network wherein a number of IoT devices 1202 are in communications with each other, for example, by radio links 1222. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 1202 are shown in this example, gateways 1204, data aggregators 1226, and sensors 1228, although any combinations of IoT devices 1202 and functionality may be used. The gateways 1204 may be edge devices that provide communications between the cloud 1200 and the fog 1220, and may also provide the backend process function for data obtained from sensors 1228, such as motion data, flow data, temperature data, and the like. The data aggregators 1226 may collect data from any number of the sensors 1228, and perform the back end processing function for the analysis. The results, raw data, or both may be passed along to the cloud 1200 through the gateways 1204. The sensors 1228 may be full IoT devices 1202, for example, capable of both collecting data and processing the data. In some cases, the sensors 1228 may be more limited in functionality, for example, collecting the data and allowing the data aggregators 1226 or gateways 1204 to process the data.

Communications from any IoT device 1202 may be passed along a convenient path (e.g., a most convenient path) between any of the IoT devices 1202 to reach the gateways 1204. In these networks, the number of interconnections provide substantial redundancy, allowing communications to be maintained, even with the loss of a number of IoT devices 1202. Further, the use of a mesh network may allow IoT devices 1202 that are very low power or located at a distance from infrastructure to be used, as the range to connect to another IoT device 1202 may be much less than the range to connect to the gateways 1204.

The fog 1220 provided from these IoT devices 1202 may be presented to devices in the cloud 1200, such as a server 1206, as a single device located at the edge of the cloud 1200, e.g., a fog device. In this example, the alerts coming from the fog device may be sent without being identified as coming from a specific IoT device 1202 within the fog 1220. In this fashion, the fog 1220 may be considered a distributed platform that provides computing and storage resources to perform processing or data-intensive tasks such as data analytics, data aggregation, and machine-learning, among others.

In some examples, the IoT devices 1202 may be configured using an imperative programming style, e.g., with each IoT device 1202 having a specific function and communication partners. However, the IoT devices 1202 forming the fog device may be configured in a declarative programming style, allowing the IoT devices 1202 to reconfigure their operations and communications, such as to determine needed resources in response to conditions, queries, and device failures. As an example, a query from a user located at a server 1206 about the operations of a subset of equipment monitored by the IoT devices 1202 may result in the fog 1220 device selecting the IoT devices 1202, such as particular sensors 1228, needed to answer the query. The data from these sensors 1228 may then be aggregated and analyzed by any combination of the sensors 1228, data aggregators 1226, or gateways 1204, before being sent on by the fog 1220 device to the server 1206 to answer the query. In this example, IoT devices 1202 in the fog 1220 may select the sensors 1228 used based on the query, such as adding data from flow sensors or temperature sensors. Further, if some of the IoT devices 1202 are not operational, other IoT devices 1202 in the fog 1220 device may provide analogous data, if available.

In other examples, the operations and functionality described above may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

FIG. 8 illustrates a drawing of a cloud computing network, or cloud 1300, in communication with a number of Internet of Things (IoT) devices. The cloud 1300 may represent the Internet, or may be a local area network (LAN), or a wide area network (WAN), such as a proprietary network for a company. The IoT devices may include any number of different types of devices, grouped in various combinations. For example, a traffic control group 1306 may include IoT devices along streets in a city. These IoT devices may include stoplights, traffic flow monitors, cameras, weather sensors, and the like. The traffic control group 1306, or other subgroups, may be in communication with the cloud 1300 through wired or wireless links 1308, such as LPWA links, optical links, and the like. Further, a wired or wireless sub-network 1312 may allow the IoT devices to communicate with each other, such as through a local area network, a wireless local area network, and the like. The IoT devices may use another device, such as a gateway 1310 or 1328 to communicate with remote locations such as the cloud 1300; the IoT devices may also use one or more servers 1330 to facilitate communication with the cloud 1300 or with the gateway 1310. For example, the one or more servers 1330 may operate as an intermediate network node to support a local edge cloud or fog implementation among a local area network. Further, the gateway 1328 that is depicted may operate in a cloud-to-gateway-to-many edge devices configuration, such as with the various IoT devices 1314, 1320, 1324 being constrained or dynamic to an assignment and use of resources in the cloud 1300.

Other example groups of IoT devices may include remote weather stations 1314, local information terminals 1316, alarm systems 1318, automated teller machines 1320, alarm panels 1322, or moving vehicles, such as emergency vehicles 1324 or other vehicles 1326, among many others. Each of these IoT devices may be in communication with other IoT devices, with FIG. 7), or a combination therein. The groups of IoT devices may be deployed in various residential, commercial, and industrial settings (including in both private or public environments).

As can be seen from FIG. 8, a large number of IoT devices may be communicating through the cloud 1300. This may allow different IoT devices to request or provide information to other devices autonomously. For example, a group of IoT devices (e.g., the traffic control group 1306) may request a current weather forecast from a group of remote weather stations 1314, which may provide the forecast without human intervention. Further, an emergency vehicle 1324 may be alerted by an automated teller machine 1320 that a burglary is in progress. As the emergency vehicle 1324 proceeds towards the automated teller machine 1320, it may access the traffic control group 1306 to request clearance to the location, for example, by lights turning red to block cross traffic at an intersection in sufficient time for the emergency vehicle 1324 to have unimpeded access to the intersection.

Clusters of IoT devices, such as the remote weather stations 1314 or the traffic control group 1306, may be equipped to communicate with other IoT devices as well as with the cloud 1300. This may allow the IoT devices to form an ad-hoc network between the devices, allowing them to function as a single device, which may be termed a fog device or system (e.g., as described above with reference to FIG. 7).

FIG. 9 is a block diagram of an example of components that may be present in an IoT device 1450 for implementing the techniques described herein. The IoT device 1450 may include any combinations of the components shown in the example or referenced in the disclosure above. The components may be implemented as ICs, portions thereof, discrete electronic devices, or other modules, logic, hardware, software, firmware, or a combination thereof adapted in the IoT device 1450, or as components otherwise incorporated within a chassis of a larger system. Additionally, the block diagram of FIG. 9 is intended to depict a high-level view of components of the IoT device 1450. However, some of the components shown may be omitted, additional components may be present, and different arrangement of the components shown may occur in other implementations.

The IoT device 1450 may include a processor 1452, which may be a microprocessor, a multi-core processor, a multithreaded processor, an ultra-low voltage processor, an embedded processor, or other known processing element. The processor 1452 may be a part of a system on a chip (SoC) in which the processor 1452 and other components are formed into a single integrated circuit, or a single package, such as the Edison™ or Galileo™ SoC boards from Intel. As an example, the processor 1452 may include an Intel® Architecture Core™ based processor, such as a Quark™, an Atom™ an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 1452 may communicate with a system memory 1454 over an interconnect 1456 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1458 may also couple to the processor 1452 via the interconnect 1456. In an example the storage 1458 may be implemented via a solid state disk drive (SSDD). Other devices that may be used for the storage 1458 include flash memory cards, such as SD cards, microSD cards, xD picture cards, and the like, and USB flash drives. In low power implementations, the storage 1458 may be on-die memory or registers associated with the processor 1452. However, in some examples, the storage 1458 may be implemented using a micro hard disk drive (HDD). Further, any number of new technologies may be used for the storage 1458 in addition to, or instead of, the technologies described, such resistance change memories, phase change memories, holographic memories, or chemical memories, among others.

The components may communicate over the interconnect 1456. The interconnect 1456 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1456 may be a proprietary bus, for example, used in a SoC based system. Other bus systems may be included, such as an 120 interface, an SPI interface, point to point interfaces, and a power bus, among others.

The interconnect 1456 may couple the processor 1452 to a mesh transceiver 1462, for communications with other mesh devices 1464. The mesh transceiver 1462 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 1464. For example, a WLAN unit may be used to implement W-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 1462 may communicate using multiple standards or radios for communications at different range. For example, the IoT device 1450 may communicate with close devices, e.g., within about 10 meters, using a local transceiver based on BLE, or another low power radio, to save power. More distant mesh devices 1464, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 1466 may be included to communicate with devices or services in the cloud 1400 via local or wide area network protocols. The wireless network transceiver 1466 may be a LPWA transceiver that follows the IEEE 802.15.4, or IEEE 802.15.4g standards, among others. The IoT device 1450 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 1462 and wireless network transceiver 1466, as described herein. For example, the radio transceivers 1462 and 1466 may include an LTE or other cellular transceiver that uses spread spectrum (SPA/SAS) communications for implementing high speed communications. Further, any number of other protocols may be used, such as W-Fi® networks for medium speed communications and provision of network communications.

The radio transceivers 1462 and 1466 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 1466, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 1468 may be included to provide a wired communication to the cloud 1400 or to other devices, such as the mesh devices 1464. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 1468 may be included to allow connect to a second network, for example, a NIC 1468 providing communications to the cloud over Ethernet, and a second NIC 1468 providing communications to other devices over another type of network.

The interconnect 1456 may couple the processor 1452 to an external interface 1470 that is used to connect external devices or subsystems. The external devices may include sensors 1472, such as accelerometers, level sensors, flow sensors, optical light sensors, camera sensors, temperature sensors, a global positioning system (GPS) sensors, pressure sensors, barometric pressure sensors, and the like. The external interface 1470 further may be used to connect the IoT device 1450 to actuators 1474, such as power switches, valve actuators, an audible sound generator, a visual warning device, and the like.

In some optional examples, various input/output (I/O) devices may be present within, or connected to, the IoT device 1450. For example, a display or other output device 1484 may be included to show information, such as sensor readings or actuator position. An input device 1086, such as a touch screen or keypad may be included to accept input. An output device 1484 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 1450.

A battery 1476 may power the IoT device 1450, although in examples in which the IoT device 1450 is mounted in a fixed location, it may have a power supply coupled to an electrical grid. The battery 1476 may be a lithium ion battery, or a metal-air battery, such as a zinc-air battery, an aluminum-air battery, a lithium-air battery, and the like.

A battery monitor/charger 1478 may be included in the IoT device 1450 to track the state of charge (SoCh) of the battery 1476. The battery monitor/charger 1478 may be used to monitor other parameters of the battery 1476 to provide failure predictions, such as the state of health (SoH) and the state of function (SoF) of the battery 1476. The battery monitor/charger 1478 may include a battery monitoring integrated circuit, such as an LTC4020 or an LTC2990 from Linear Technologies, an ADT7488A from ON Semiconductor of Phoenix, Ariz., or an IC from the UCD90xxx family from Texas Instruments of Dallas, Tex. The battery monitor/charger 1478 may communicate the information on the battery 1476 to the processor 1452 over the interconnect 1456. The battery monitor/charger 1478 may also include an analog-to-digital (ADC) convertor that allows the processor 1452 to directly monitor the voltage of the battery 1476 or the current flow from the battery 1476. The battery parameters may be used to determine actions that the IoT device 1450 may perform, such as transmission frequency, mesh network operation, sensing frequency, and the like.

A power block 1480, or other power supply coupled to a grid, may be coupled with the battery monitor/charger 1478 to charge the battery 1476. In some examples, the power block 1480 may be replaced with a wireless power receiver to obtain the power wirelessly, for example, through a loop antenna in the IoT device 1450. A wireless battery charging circuit, such as an LTC4020 chip from Linear Technologies of Milpitas, Calif., among others, may be included in the battery monitor/charger 1478. The specific charging circuits chosen depend on the size of the battery 1476, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1458 may include instructions 1482 in the form of software, firmware, or hardware commands to implement the techniques described herein. Although such instructions 1482 are shown as code blocks included in the memory 1454 and the storage 1458, it may be understood that any of the code blocks may be replaced with hardwired circuits, for example, built into an application specific integrated circuit (ASIC).

In an example, the instructions 1482 provided via the memory 1454, the storage 1458, or the processor 1452 may be embodied as a non-transitory, machine readable medium 1460 including code to direct the processor 1452 to perform electronic operations in the IoT device 1450. The processor 1452 may access the non-transitory, machine readable medium 1460 over the interconnect 1456. For instance, the non-transitory, machine readable medium 1460 may be embodied by devices described for the storage 1458 of FIG. 8 or may include specific storage units such as optical disks, flash drives, or any number of other hardware devices. The non-transitory, machine readable medium 1460 may include instructions to direct the processor 1452 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

### EXAMPLES

The following examples pertain to further embodiments. Example 1 is a system for targeted electronic messaging at a brick and mortar store, comprising a shopper tracking system disposed within the brick and mortar store to collect shopping behavior data of a shopper within the brick and mortar store, and tracks a physical location of the shopper while the shopper is in the brick and mortar store; and an electronic sign disposed within the brick and mortar store to display electronic messages; wherein the shopper tracking system provides continuously the shopping behavior data to a real time bidding system remote from the brick and mortar store, and provides a notification to the real time bidding system when the shopper is within a predetermined distance to the electronic sign, to cause the real time bidding system to display an electronic message in or during a message slot of the electronic sign for the shopper, the electronic message being of a contemporaneous winning bidder of the real time bidding system for the message slot.

In Example 2, the subject matter of Example 1 can optionally include a shopping behavior data collector to collect the shopping behavior data via RFID signal interference, the RFID signal interference generated by the shopper as the shopper passes between an RFID tag disposed upon an item within the brick and mortar store and an RFID reader in communication with the shopping behavior data collector.

In Example 3, the subject matter of any one of Examples 1-2 can optionally include a shopper tracker that tracks the shopper's physical location using a physical device unique to and in the physical possession of the shopper.

In Example 4, the subject matter of Example 3 can optionally include a smartphone as the physical device unique to and in the physical possession of the shopper.

In Example 5, the subject matter of Example 4 can optionally use the smartphone to track the shopper's physical location via a combination of sensors within the smartphone and WiFi fingerprinting of the smartphone.

In Example 6, the subject matter of Examples 1-4 can optionally include a shopping behavior data collector that collects the shopping behavior data using facial and object recognition.

In Example 7, the subject matter of Examples 1-5 can optionally have the message slot of the electronic sign comprise a specified time window during which the electronic message is displayed for the shopper.

In Example 8, the subject matter of Examples 1-6 can optionally have the message slot of the electronic sign comprise a physical area that is at least a portion of a display on the electronic sign within which the electronic message is displayed.

Example 9 is a method for providing targeted messaging at a brick and mortar store, comprising collecting, by a shopper tracking system disposed within the brick and mortar store, shopping behavior data of a shopper within the brick and mortar store; tracking, by the shopper tracking system, a physical location of the shopper within the brick and mortar store; continuously communicating by the shopper tracking system the shopping behavior data to a real time bidding system remote from the brick and mortar store; and notifying the real time bidding system by the shopper tracking system when the shopper is within a predetermined distance to an electronic sign, to cause the real time bidding system to display an electronic message in or during a message slot of the electronic sign for the shopper, the electronic message being of a contemporaneous winning bidder of the real time bidding system for the message slot.

In Example 10, the subject matter of Example 9 can optionally include the shopping behavior data being collected via RFID signal interference, the RFID signal interference generated by the shopper as the shopper passes between an RFID tag disposed upon an item within the brick and mortar store and an RFID reader in communication with a shopping behavior data collector.

In Example 11, the subject matter of Examples 9 or 10 can optionally include the shopper's physical location being tracked using a physical device unique to and in the physical possession of the shopper.

In Example 12, the subject matter of Example 11 can optionally include a smartphone as the physical device unique to and in the physical possession of the shopper.

In Example 13, the subject matter of Example 12 can optionally use the smartphone to track the shopper's physical location via a combination of sensors within the smartphone and WiFi fingerprinting of the smartphone.

In Example 14, the subject matter of Examples 9-13 can optionally include the shopping behavior data being collected using facial and object recognition.

In Example 15, the subject matter of Examples 9-14 optionally include the message slot of the electronic sign comprising a specified time window during which the electronic message is displayed for the shopper.

In Example 16, the subject matter of Examples 9-15 optionally include a physical area of the message slot that is at least a portion of a display on the electronic sign within which the electronic message is displayed.

Example 17 is a non-transitory computer-readable medium comprising instructions to cause a shopper tracking system at a brick and mortar store, in response to execution of the instructions by a processor, to collect shopping behavior data of a shopper within the brick and mortar store; track a physical location of the shopper within the brick and mortar store; provide continuously the shopping behavior data to a real-time bidding system remote from the brick and mortar store; and notify the real time bidding system when the shopper is within a predetermined distance to an electronic sign, to cause the real time bidding system to display an electronic message in or during a message slot of the electronic sign for the shopper, the electronic message being of a contemporaneous winning bidder of the real time bidding system for the message slot.

In Example 18, the subject matter of Example 17 can optionally include instructions that further cause the shopper tracking system to collect the shopping behavior data via RFID signal interference, the RFID signal interference generated by the shopper as the shopper passes between an RFID tag disposed upon an item within the brick and mortar store and an RFID reader in communication with a shopping behavior data collector.

In Example 19, the subject matter of Examples 17 or 18 can optionally include instructions that further cause the shopper tracking system to track the shopper's physical location using a physical device unique to and in the physical possession of the shopper.

In Example 20, the subject matter of Example 19 can optionally include a smartphone as the physical device unique to and in the physical possession of the shopper.

In Example 21, the subject matter of Example 20 can optionally include instructions that further cause the shopper tracking system to track the shopper's physical location via a combination of sensors within the smartphone and WiFi fingerprinting of the smartphone.

In Example 22, the subject matter of Examples 17-21 can optionally include instructions that further cause the shopper tracking system to collect shopping behavior data using facial and object recognition.

In Example 23, the subject matter of Examples 17-22 can optionally include the message slot of the electronic sign comprising a specified time window during which the electronic message is displayed for the shopper.

In Example 24, the subject matter of Examples 17-23 can optionally include a physical area of the message slot that is at least a portion of a display on the electronic sign within which the electronic message is displayed.

Example 25 is a system for targeted electronic messaging at a brick and mortar store, comprising shopper tracking means for collecting shopping behavior data of a shopper within the brick and mortar store and tracking a physical location of the shopper within the brick and mortar store; and display means disposed within the brick and mortar store to display electronic messages; wherein the shopper tracking means includes means for providing continuously the shopping behavior data to a real time bidding means remote from the brick and mortar store, and means for providing a notification to the real time bidding means when the shopper is within a predetermined distance to the display means, to cause the real time bidding means to display an electronic message in or during a message slot of the display means for the shopper, the electronic message being of a contemporaneous winning bidder of the real time bidding means for the message slot.

In Example 26, the subject matter of Example 25 can optionally include a shopping behavior data collection means for collecting the shopping behavior data via RFID signal interference, the RFID signal interference generated by the shopper as the shopper passes between an RFID tag disposed upon an item within the brick and mortar store and an RFID reader in communication with the shopping behavior data collection means.

In Example 27, the subject matter of Example 25 or 26 can optionally include a shopper tracker means for tracking the shopper's physical location using a physical device unique to and in the physical possession of the shopper.

In Example 28, the subject matter of Example 27 can optionally include a smartphone as the physical device unique to and in the physical possession of the shopper.

In Example 29, the subject matter of Example 28 can optionally include using the smartphone to track the shopper's physical location via a combination of sensors within the smartphone and WiFi fingerprinting of the smartphone.

In Example 30, the subject matter of Examples 25-29 can optionally include a shopping behavior data collection means for collecting the shopping behavior data using facial and object recognition.

In Example 31, the subject matter of Examples 25-30 can optionally include a display means wherein the message slot comprises a specified time window during which the electronic message is displayed for the shopper.

In Example 32, the subject matter of Examples 25-31 can optionally include a display means wherein the message slot comprises a physical area that is at least a portion of a display on the display means within which the electronic message is displayed.

What is claimed is:

1. A system for targeted electronic messaging at a brick and mortar store, comprising:
a shopper tracking system disposed within the brick and mortar store to collect shopping behavior data of a shopper within the brick and mortar store, and tracks a physical location of the shopper while the shopper is in the brick and mortar store; and
an electronic sign disposed within the brick and mortar store to display electronic messages;
wherein the shopper tracking system provides continuously the shopping behavior data to a real time bidding system remote from the brick and mortar store, and provides a notification to the real time bidding system when the shopper is within a predetermined distance to the electronic sign, to cause the real time bidding system to display an electronic message in or during a message slot of the electronic sign for the shopper, the electronic message being of a contemporaneous winning bidder of the real time bidding system for the message slot.

2. The system of claim 1, wherein the shopper tracking system includes a shopping behavior data collector to collect the shopping behavior data via RFID signal interference, the RFID signal interference generated by the shopper as the shopper passes between an RFID tag disposed upon an item within the brick and mortar store and an RFID reader in communication with the shopping behavior data collector.

3. The system of claim 1, wherein the shopper tracking system includes a shopper tracker that tracks the shopper's physical location using a physical device unique to and in the physical possession of the shopper.

4. The system of claim 3, wherein the physical device unique to and in the physical possession of the shopper comprises a smartphone.

5. The system of claim 4, wherein the shopper tracker uses the smartphone to track the shopper's physical location via a combination of sensors within the smartphone and WiFi fingerprinting of the smartphone.

6. The system of claim 1, wherein the shopper tracking system includes a shopping behavior data collector that collects the shopping behavior data using facial and object recognition.

7. The system of claim 1, wherein the message slot of the electronic sign comprises a specified time window during which the electronic message is displayed for the shopper.

8. The system of claim 1, wherein the message slot of the electronic sign comprises a physical area that is at least a portion of a display on the electronic sign within which the electronic message is displayed.

9. A method for providing targeted messaging at a brick and mortar store, comprising:
collecting, by a shopper tracking system disposed within the brick and mortar store, shopping behavior data of a shopper within the brick and mortar store;
tracking, by the shopper tracking system, a physical location of the shopper within the brick and mortar store;
continuously communicating by the shopper tracking system the shopping behavior data to a real time bidding system remote from the brick and mortar store; and
notifying the real time bidding system by the shopper tracking system when the shopper is within a predetermined distance to an electronic sign, to cause the real time bidding system to display an electronic message in or during a message slot of the electronic sign for the shopper, the electronic message being of a contemporaneous winning bidder of the real time bidding system for the message slot.

10. The method of claim 9, wherein the shopping behavior data is collected via RFID signal interference, the RFID signal interference generated by the shopper as the shopper passes between an RFID tag disposed upon an item within the brick and mortar store and an RFID reader in communication with a shopping behavior data collector.

11. The method of claim 9, wherein the shopper's physical location is tracked using a physical device unique to and in the physical possession of the shopper.

12. The method of claim 9, wherein the shopping behavior data is collected using facial and object recognition.

13. The method of claim 9, wherein the message slot of the electronic sign comprises a specified time window during which the electronic message is displayed for the shopper.

14. The method of claim 13, wherein the message slot of the electronic sign comprises a physical area that is at least a portion of a display on the electronic sign within which the electronic message is displayed.

15. A non-transitory computer-readable medium comprising instructions to cause a shopper tracking system at a brick and mortar store, in response to execution of the instructions by a processor, to:
collect shopping behavior data of a shopper within the brick and mortar store;
track a physical location of the shopper within the brick and mortar store;
provide continuously the shopping behavior data to a real-time bidding system remote from the brick and mortar store; and
notify the real time bidding system when the shopper is within a predetermined distance to an electronic sign, to cause the real time bidding system to display an electronic message in or during a message slot of the electronic sign for the shopper, the electronic message being of a contemporaneous winning bidder of the real time bidding system for the message slot.

16. The computer-readable medium of claim 15, wherein the instructions further cause the shopper tracking system to collect the shopping behavior data via RFID signal interference, the RFID signal interference generated by the shopper as the shopper passes between an RFID tag disposed upon an item within the brick and mortar store and an RFID reader in communication with a shopping behavior data collector.

17. The computer-readable medium of claim 15, wherein the instructions further cause the shopper tracking system to track the shopper's physical location using a physical device unique to and in the physical possession of the shopper.

18. The computer-readable medium of claim 17, wherein the physical device unique to and in the physical possession of the shopper comprises a smartphone.

19. The computer-readable medium of claim 18, wherein the instructions further cause the shopper tracking system to track the shopper's physical location via a combination of sensors within the smartphone and WiFi fingerprinting of the smartphone.

20. The computer-readable medium of claim 15, wherein the message slot of the electronic sign comprises a specified time window during which the electronic message is displayed for the shopper.

21. The computer-readable medium of claim 15, wherein the message slot of the electronic sign comprises a physical area that is at least a portion of a display on the electronic sign within which the electronic message is displayed.

22. A system for targeted electronic messaging at a brick and mortar store, comprising:
shopper tracking means for collecting shopping behavior data of a shopper within the brick and mortar store and tracking a physical location of the shopper within the brick and mortar store; and
display means disposed within the brick and mortar store to display electronic messages;
wherein the shopper tracking means includes:
means for providing continuously the shopping behavior data to a real time bidding means remote from the brick and mortar store, and
means for providing a notification to the real time bidding means when the shopper is within a predetermined distance to the display means, to cause the real time bidding means to display an electronic message in or during a message slot of the display means for the shopper, the electronic message being of a contemporaneous winning bidder of the real time bidding means for the message slot.

23. The system of claim 22, wherein the shopper tracking means includes a shopping behavior data collection means for collecting the shopping behavior data via RFID signal interference, the RFID signal interference generated by the shopper as the shopper passes between an RFID tag disposed upon an item within the brick and mortar store and an RFID reader in communication with the shopping behavior data collection means.

24. The system of claim 22, wherein the shopper tracking means includes a shopper tracker means for tracking the shopper's physical location using a physical device unique to and in the physical possession of the shopper.

25. The system of claim 22, wherein the shopper tracking means includes a shopping behavior data collection means for collecting the shopping behavior data using facial and object recognition.
